(19) United States
(12) Patent Application Publication
(10) Pub. No.: US 2015/0262103 A1
(43) Pub. Date: Sep. 17, 2015

(54) APPARATUS AND METHOD FOR MANAGING SHOP USING LIGHTING NETWORK AND VISIBLE LIGHT COMMUNICATION

(71) Applicant: ELECTRONICS AND TELECOMMUNICATIONS RESEARCH INSTITUTE, Daejeon (KR)

(72) Inventors: Hyun-Jong KIM, Cheongju-si (KR); You-Jin KIM, Daejeon (KR); Dae-Ho KIM, Daejeon (KR); Hyun-Seok KIM, Daejeon (KR); Tae-Gyu KANG, Daejeon (KR)

(73) Assignee: ELECTRONICS AND TELECOMMUNICATIONS RESEARCH INSTITUTE, Daejeon (KR)

(21) Appl. No.: 14/643,956

(22) Filed: Mar. 10, 2015

(30) Foreign Application Priority Data
Mar. 11, 2014 (KR) 10-2014-0028074

(51) Int. Cl. G06Q 10/06; H05B 33/08; H05B 37/02; G06Q 30/02; H04N 5/85

(52) U.S. Cl. CPC G06Q 10/06313; G06Q 30/0261; H04N 5/85; H05B 37/0272; H05B 33/0854

(57) ABSTRACT

A shop management apparatus and method are disclosed therein. The apparatus includes an input unit, a product information management unit, a communication unit, and a shop management unit. The input unit receives product information and discount event information within a shop. The product information management unit compares the product information and the discount event information with previously stored information, sends changed product information and changed discount event information, acquired based on a result of the comparison, to a lighting control scheduler, and receives a corresponding reception Ack message. The communication unit receives VLC data and illuminance information for each light ID, corresponding to the product information and the discount event information, from a portable manager device. The shop management unit checks an error of the VLC data, checks the illuminance of a corresponding LED light within the shop based on the illuminance information, and then manages the shop.

### CROSS-REFERENCE TO RELATED APPLICATION

This application claims the benefit of Korean Patent Application No. 10-2014-0028074, filed Mar. 11, 2014, which is hereby incorporated by reference herein in its entirety.

### BACKGROUND

1. Technical Field

The present invention relates generally to an apparatus and method for managing a shop using a lighting network and visible light communication and, more particularly, to an apparatus and method for managing a shop, which are capable of providing information about a product, such as the price of the product and discount event details related to the product, frequently changed in the shop, in real time using a lighting network capable of controlling the brightness of light-emitting diode (LED) lights within the shop and visible light communication (VLC), and are also capable of checking whether the brightness of an LED light controlled by a lighting control scheduler based on the information about the product has been appropriately controlled.

2. Description of the Related Art

There is an increasing need to reduce building energy consumption in order to solve a lack of electricity because lighting within a building accounts for about 36% or more of the total building energy cost. Energy can be reduced by turning off unnecessary lights or reducing the brightness of lights through control of the lights using a lighting control network and system according to circumstances.

Networks and protocols that are now being considered for lighting control include DALI, DMX512, Ethernet, Wi-Fi, and ZigBee.

VLC is an international standard (IEEE 802.15.7) wireless communication technology which is capable of sending data using a ray of light that belongs to electromagnetic waves and that has a wavelength ranging from 380 to 780 nm visible to the human eye.

As described above, light can be controlled and a variety of VLC services can be provided through the combination of the VLC technology and a lighting control network. In this case, the term “VLC service” refers to a service in which data is transmitted or received over a lighting control network using VLC technology or the location of an object is determined.

An electronic shelf label (ESL) system is a system in which ESL devices for displaying the prices of products are installed in a distribution market and changes in the price and discount information of corresponding products are transmitted in real time over a wired/wireless network, thereby enabling purchasers to receive accurate product information.

For example, Korean Patent Application Publication No. 10-2010-0128906 entitled “Terminal, System and Method for Electronic Shelf Label using Radio-Frequency Identification” discloses an ESL terminal, system and method using an RFID method, which are capable of selecting a plurality of ESL terminals in real time, updating price information, and minimizing power consumption.

As described above, such conventional ESL systems are disadvantageous in that a wireless network, such as a ZigBee or RFID network, must be additionally constructed and whether a product price and discount event information transmitted by a shop management system have been correctly transmitted must be checked directly via an ESL device.

### SUMMARY

At least some embodiments of the present invention are directed to the provision of an apparatus and method for managing a shop, which are capable of providing information about a product, such as the price of the product and discount event details related to the product, frequently changed in the shop, in real time using a lighting network capable of controlling the brightness of LED lights within the shop and visible light communication (VLC), and are also capable of checking whether the brightness of an LED light controlled by a lighting control scheduler based on the information about the product has been appropriately controlled.

In accordance with an aspect of the present invention, there is provided a method of managing a shop, including receiving, by a shop management apparatus, product information and discount event information within a shop; comparing the product information and the discount event information with previously stored information, sending changed product information and changed discount event information, acquired based on a result of the comparison, to a lighting control scheduler, and receiving a corresponding reception Ack message; receiving visible light communication (VLC) data and illuminance information for each light identification (ID), corresponding to the product information and the discount event information, from a portable manager device; and checking an error of the VLC data, checking the illuminance of a corresponding LED light within the shop based on the illuminance information, and then managing the shop.

Receiving the VLC data and the illuminance information may include receiving the VLC data and the illuminance information via Wi-Fi communication.

The method may further include, after receiving the reception Ack message, searching for, by the lighting control scheduler, an Internet Protocol (IP) address of an light-emitting diode (LED) light corresponding to each light ID; and sending product information and discount event information, corresponding to each product ID, to the LED light using the IP address of the LED light, and receiving a corresponding reception Ack message.

The lighting control scheduler and the LED light may be connected over a lighting network.

The method may further including sending, by the LED light, the product information and the discount event information to an ESL device or the portable manager device within the shop using a corresponding VLC receiver via VLC.

Managing the shop may include controlling product advertising video data included in the VLC data so that the product advertising video data is played back using a video player installed in the shop.

In accordance with another aspect of the present invention, there is provided an apparatus for managing a shop, including an input unit configured to receive product information and discount event information within a shop; a product information management unit configured to compare the product information and the discount event information with previously stored information, to send changed product information and changed discount event information, acquired based on a result of the comparison, to a lighting control scheduler, and to receive a corresponding reception Ack message; a communication unit configured to receive VLC data and illuminance information for each light ID, corresponding to the product information and the discount event information, from a portable manager device; and a shop management unit configured to check an error of the VLC data, to check the illuminance of a corresponding LED light within the shop based on the illuminance information, and to then manage the shop.

The communication unit may receive the VLC data and the illuminance information via Wi-Fi communication.

After the product information management unit has received the reception Ack message, the lighting control scheduler may search for an IP address of an LED light corresponding to each light ID, and may send product information and discount event information, corresponding to each product ID, to the LED light using the IP address of the LED light.

The lighting control scheduler and the LED light may be connected over a lighting network.

The LED light may send the product information and the discount event information to an ESL device or the portable manager device within the shop using a corresponding VLC receiver via VLC.

The shop management unit may perform control so that product advertising video data included in the VLC data is played back using a video player installed in the shop.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a shop management environment to which a shop management apparatus using a lighting network and visible light communication according to an embodiment of the present invention may be applied;

FIG. 2 is a diagram illustrating information transmitted to an LED light over a lighting control network according to an embodiment of the present invention;

FIGS. 3 and 4 are diagrams illustrating the structures of a VLC data frame according to an embodiment of the present invention;

FIG. 5 is a flowchart illustrating a shop management method according to an embodiment of the present invention;

FIG. 6 is a flowchart illustrating an electronic shelf labeling (ESL) method using VLC in a shop management apparatus according to an embodiment of the present invention;

FIG. 7 is a flowchart illustrating an ESL method using VLC in a lighting control scheduler according to an embodiment of the present invention;

FIG. 8 is a diagram illustrating a shop product information management table according to an embodiment of the present invention;

FIG. 9 is a diagram illustrating a light ID-IP address mapping table according to an embodiment of the present invention;

FIG. 10 is a diagram schematically illustrating the configuration of an LED light according to an embodiment of the present invention;

FIG. 11 is a flowchart illustrating the operation of the LED light according to an embodiment of the present invention;

FIG. 12 is a diagram schematically illustrating the configurations of a VLC receiver and an ESL terminal according to embodiments of the present invention;

FIG. 13 is a flowchart illustrating the operation of the ESL terminal according to an embodiment of the present invention;

FIG. 14 is a flowchart illustrating a process of playing back a product advertising video on a video player connected to the VLC receiver according to an embodiment of the present invention;

FIG. 15 is a diagram schematically illustrating the configuration of a VLC receiver for a portable manager device according to an embodiment of the present invention; and

FIG. 16 is a flowchart illustrating the operation of the portable manager device according to an embodiment of the present invention.

### DETAILED DESCRIPTION

Embodiments of the present invention will be described in detail below with reference to the accompanying drawings. Repeated descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

An apparatus and method for managing a shop using a lighting network and visible light communication according to embodiments of the present invention are described in detail below with reference to the accompanying drawings.

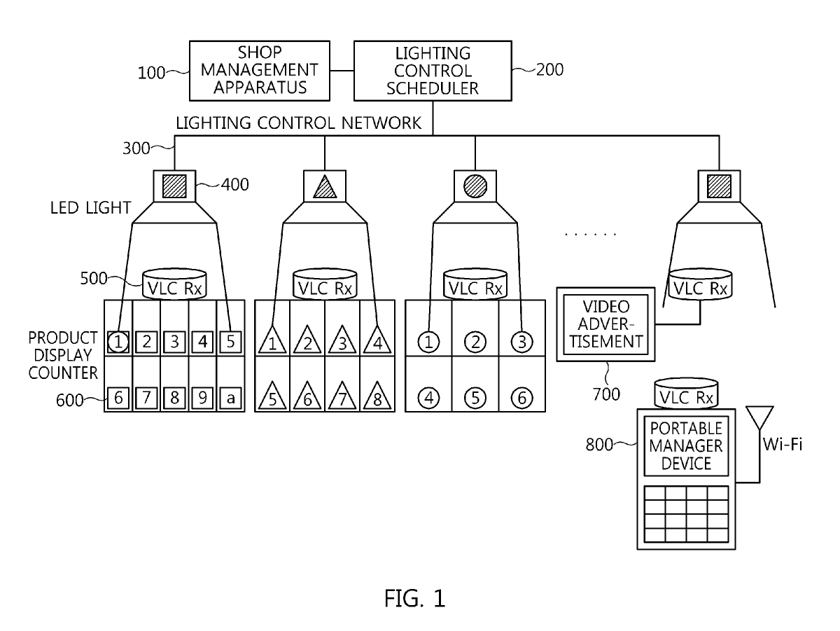

FIG. 1 is a diagram illustrating a shop management environment to which a shop management apparatus using a lighting network and visible light communication according to an embodiment of the present invention may be applied.

Referring to FIG. 1, the shop management environment according to the present embodiment may include a shop management apparatus 100, a lighting control scheduler 200, a lighting control network 300, LED lights 400, VLC receivers 500, ESL terminals 600, a video player 700, and a portable manager device 800.

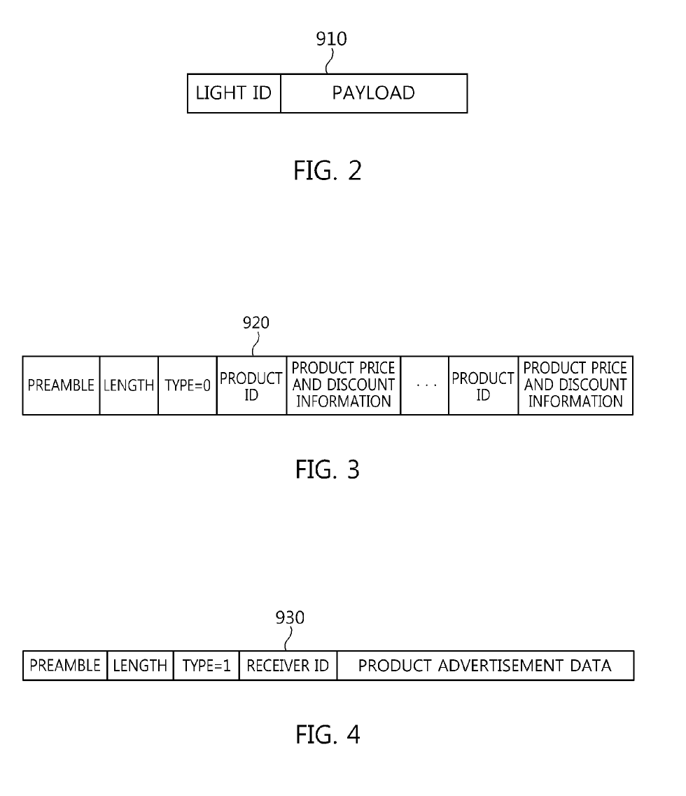

The shop management apparatus 100 manages product information, such as the number of products in stock and the locations and prices of products within a shop, and discount event information, and sends changed product information and discount event information to the LED lights 400 capable of VLC over the lighting control network 300 while operating in conjunction with the lighting control scheduler 200. In this case, the information transmitted to the LED lights 400 over the lighting control network 300 may have a form, such as that of FIG. 2. Referring to FIG. 2, information 910 transmitted to the LED lights 400 over the lighting control network 300 includes a light ID and payload corresponding to a specific LED light 400.

Each of the LED lights 400 receives only information corresponding to its own ID, converts the received information into VLC data using a photoelectric conversion function, and sends the VLC data, i.e., the results of the conversion, using visible light. In this case, the frame of the VLC data may be the same as that of FIG. 3.

FIG. 3 is a diagram illustrating the structure of a VLC data frame including a product price and discount event information for each product ID.

Each of the VLC receivers 500 receives data transmitted following a preamble signal, converts the received data using a photoelectric conversion function, and sends product information and discount event information for each product ID to the ESL terminals 600.

Each of the ESL terminals 600 stores information received for each of products within a product display counter in a shop, for example, product information and discount event information, and displays the stored information.

A shop manager carries the portable manager device 800, receives VLC data from the LED lights 400 in an area in which corresponding products are displayed, and sends the received VLC data to the shop management apparatus 100 over a Wi-Fi network so that whether changed information has been appropriately transmitted is checked.

The video player 700 installed in a shop receives product advertising video data from the shop management apparatus 100 over the lighting control network 300, and plays back the product advertising video data. The product advertising video data received over the lighting control network 300 may have a form, such as that of FIG. 4.

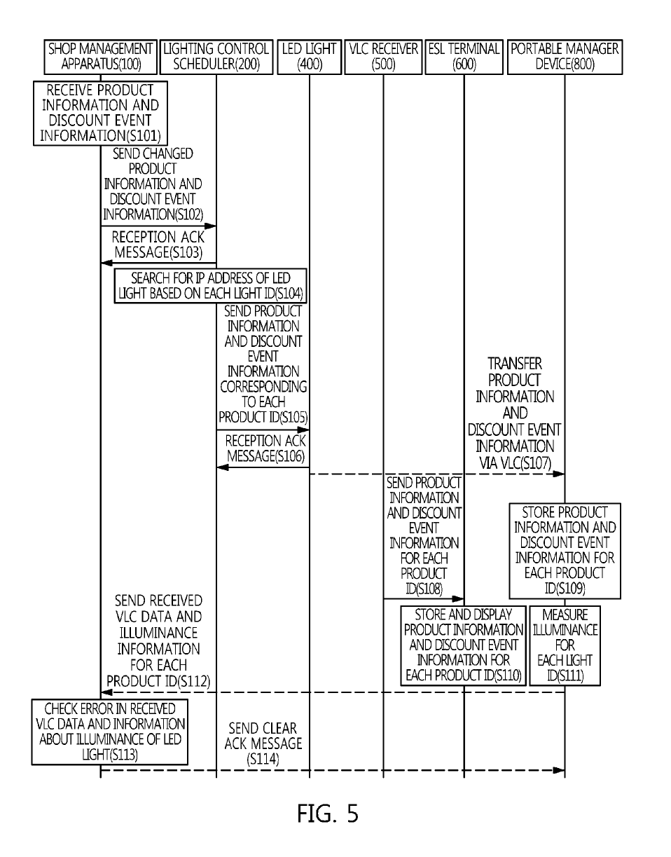

A shop management method performed by the shop management apparatus in a shop management environment, such as that of FIG. 1, is described in detail below with reference to FIG. 5.

FIG. 5 is a flowchart illustrating a shop management method according to an embodiment of the present invention.

First, a shop management apparatus 100 according to the present embodiment may include an input unit, a product information management unit, a communication unit, and a shop management unit, but is not limited thereto.

Referring to FIG. 5, a shop management environment according to the present embodiment includes a shop management apparatus 100, a lighting control scheduler 200, an LED light 400, a VLC receiver 500, an ESL terminal 600, and a portable manager device 800.

The input unit of the shop management apparatus 100 receives product information, such as the number of products in stock and the locations and prices of products within a shop, and discount event information at step S101.

The product management unit of the shop management apparatus 100 compares the product information and discount event information, received at step S101, with previously stored information, sends changed product information and discount event information based on the result of the comparison to the lighting control scheduler 200 at step S102, and receives a corresponding reception Ack message from the lighting control scheduler 200 at step S103.

The lighting control scheduler 200 searches for the IP address of the LED light 400 based on each light ID at step S104. At step S105, the lighting control scheduler 200 sends product information and discount event information, corresponding to each product ID, to the LED light 400 using the IP address of the LED light 400 retrieved at step S104. The lighting control scheduler 200 receives a reception Ack message from the LED light 400 at step S106.

The LED light 400 transfers the product information and discount event information, received at step S105, to the VLC receiver 500 and the portable manager device 800 using VLC at step S107.

The VLC receiver 500 sends the product information and discount event information for each product ID, received at step S107, to the ESL terminal 600 at step S108.

At step S109, the portable manager device 800 stores the product information and discount event information for each product ID received at step S107.

At step S110, the ESL terminal 600 stores and displays the product information and discount event information for each product ID received at step S108.

After step S109, the portable manager device 800 measures illuminance for each light ID using an illuminance sensor (not illustrated) at step S111. The portable manager device 800 sends VLC data received from the LED light 400, i.e., the product information, discount event information, and illuminance information for each product ID, to the communication unit of the shop management apparatus 100 over a Wi-Fi network at step S112.

The shop management unit of the shop management apparatus 100 checks whether there is an error in the VLC data, received at step S112, and information about the illuminance of the LED light 400 at step S113, and sends the result of the checking, i.e., a clear Ack message, to the portable manager device 800 at step S114.

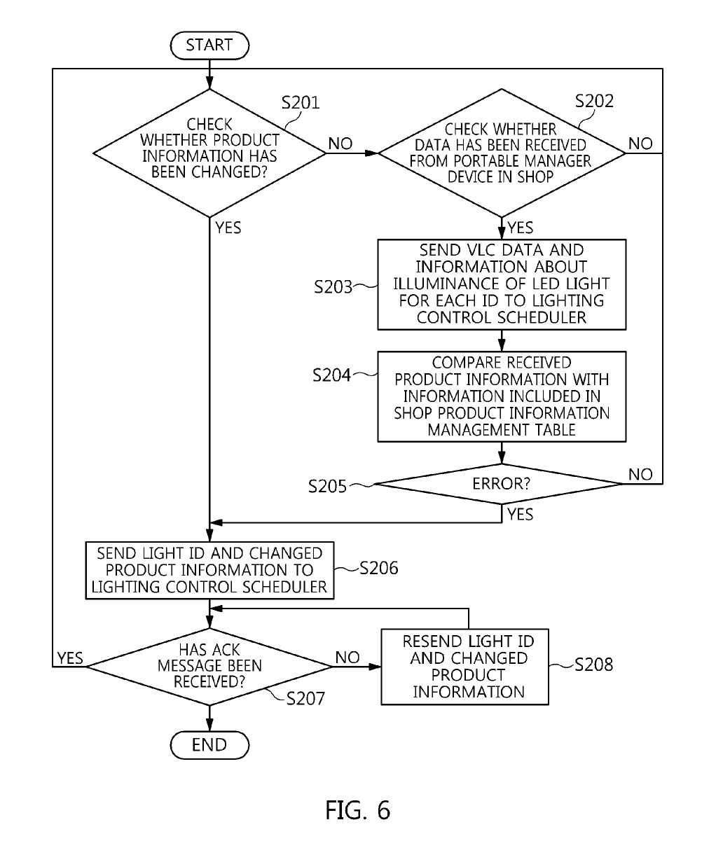

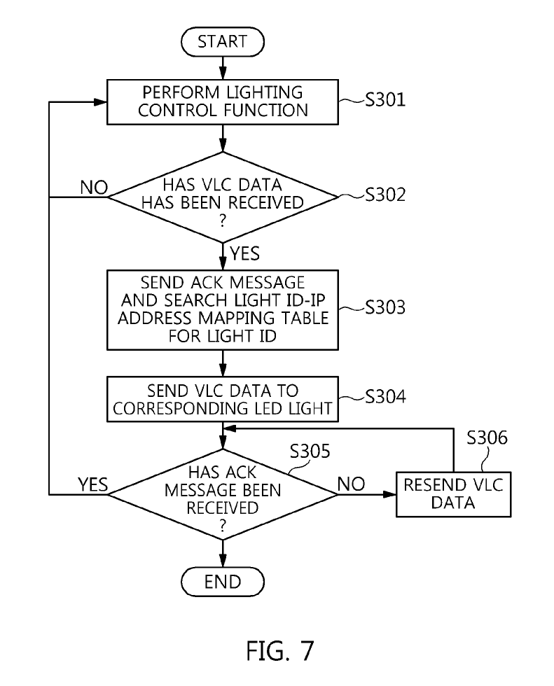

An ESL method using VLC performed by the shop management apparatus 100 and the lighting control scheduler 200 is described in detail with referenced to FIGS. 6 and 7.

FIG. 6 is a flowchart illustrating an ESL method using VLC in the shop management apparatus according to an embodiment of the present invention.

Referring to FIG. 6, the shop management apparatus 100 checks whether product information, such as the number of products in stock and the locations and prices of products within a shop, has been changed at step S201.

If, as a result of the checking, it is determined that the product information has not been changed, the shop management apparatus 100 checks whether data, i.e., VLC data and information about the illuminance of the LED light 400 for each ID, has been received from the portable manager device 800 in a shop at step S202.

If, as a result of the checking, it is determined that the data has been received, the shop management apparatus 100 sends the VLC data and the information about the illuminance of the LED light 400 for each ID to the lighting control scheduler 200 at step S203.

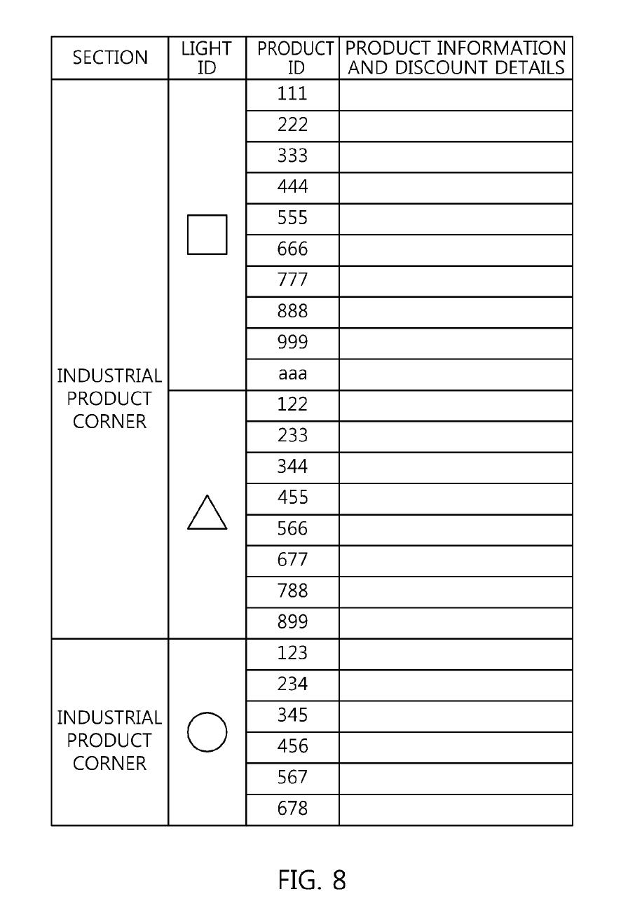

The shop management apparatus 100 checks whether product information included in the VLC data received at step S202 is identical with information included in a shop product information management table, such as that of FIG. 8, at step S204. Referring to FIG. 8, the shop product information management table includes light IDs, product IDs, product information, and discount details for each section, for example, an industrial product corner or a vegetable corner.

At step S205, the shop management apparatus 100 determines whether the product information has been changed or new product information has been added based on the result of the checking at step S204.

If, as a result of the checking at step S201, it is determined that the product information has been changed, the shop management apparatus 100 sends a light ID and the changed product information to the lighting control scheduler 200 at step S206.

The shop management apparatus 100 checks whether an Ack message has been received from the lighting control scheduler 200 at step S207. If, as a result of the checking, it is determined that the Ack message has not been received, the shop management apparatus 100 resends the light ID and the changed product information to the lighting control scheduler 200 at step S208. If such a phenomenon is repeated, a shop manager recognizes that an error has occurred in the ESL terminal 600.

FIG. 7 is a flowchart illustrating an electronic shelf labeling (ESL) method using VLC in the lighting control scheduler according to an embodiment of the present invention.

Referring to FIG. 7, at normal times, the lighting control scheduler 200 performs a light control function at step S301.

The lighting control scheduler 200 checks whether VLC data has been received from the shop management apparatus 100 at step S302.

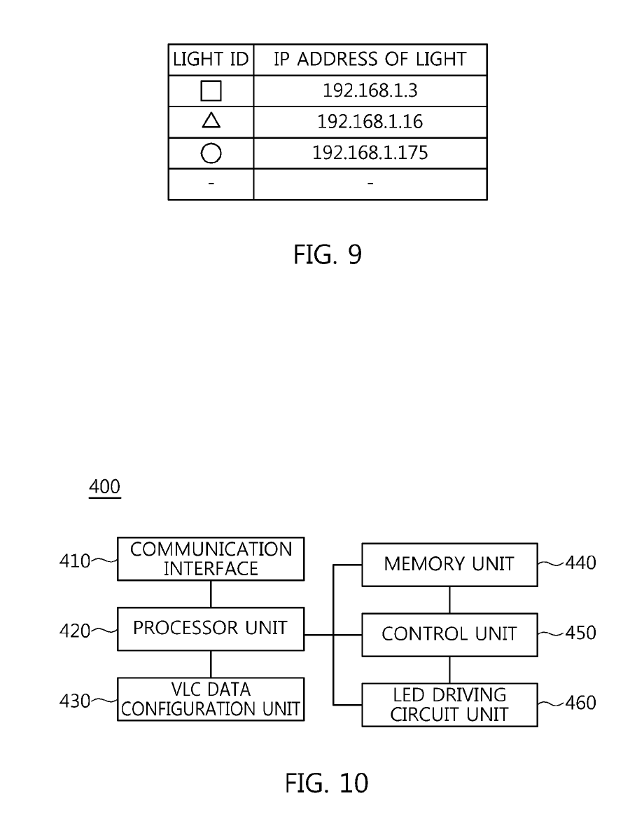

If, as a result of the checking, it is determined that the VLC data has been received, the lighting control scheduler 200 sends an Ack message indicating that the VLC data has been received and searches a light ID-IP address mapping table for a light ID corresponding to the VLC data and the IP address of a corresponding LED light 400 at step S303. In this case, the light ID-IP address mapping table may be the same as that of FIG. 9.

The lighting control scheduler 200 sends VLC data, retrieved at step S303, to the corresponding LED light 400 at step S304.

The lighting control scheduler 200 checks whether an Ack message indicating that the VLC data has been received has been received from the LED light 400 at step S305, and resends the VLC data to the corresponding LED light 400 based on the result of the checking at step S306.

An LED light 400 is described in detail with reference to FIG. 10.

FIG. 10 is a diagram schematically illustrating the configuration of an LED light 400 according to an embodiment of the present invention.

Referring to FIG. 10, the LED light 400 may include a communication interface 410, a processor unit 420, a VLC data configuration unit 430, a memory unit 440, a control unit 450, and an LED driving circuit unit 460.

The communication interface 410 performs communication over the lighting control network 300.

The processor unit 420 controls the overall operation of the LED light 400 capable of VLC.

The VLC data configuration unit 430 configures data in conformity with the specifications of a VLC data frame, such as those of FIGS. 3 and 4.

The memory unit 440 stores VLC data received from the lighting control scheduler 200.

The control unit 450 controls the transmission of VLC data and the brightness of the LED light.

The LED driving circuit unit 460 includes a circuit that drives an LED chip.

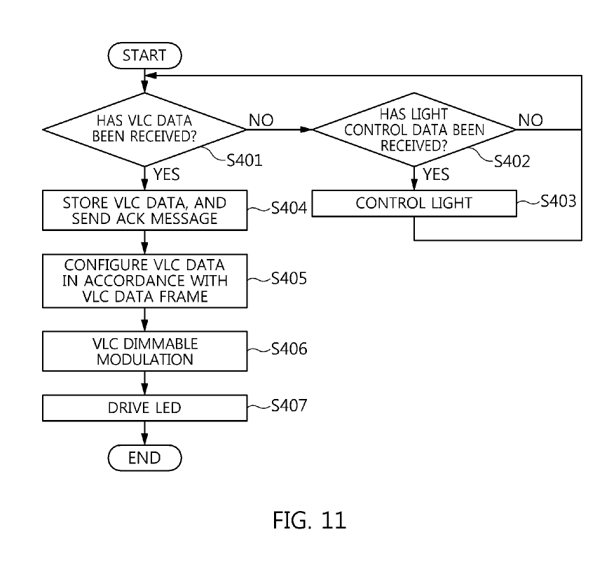

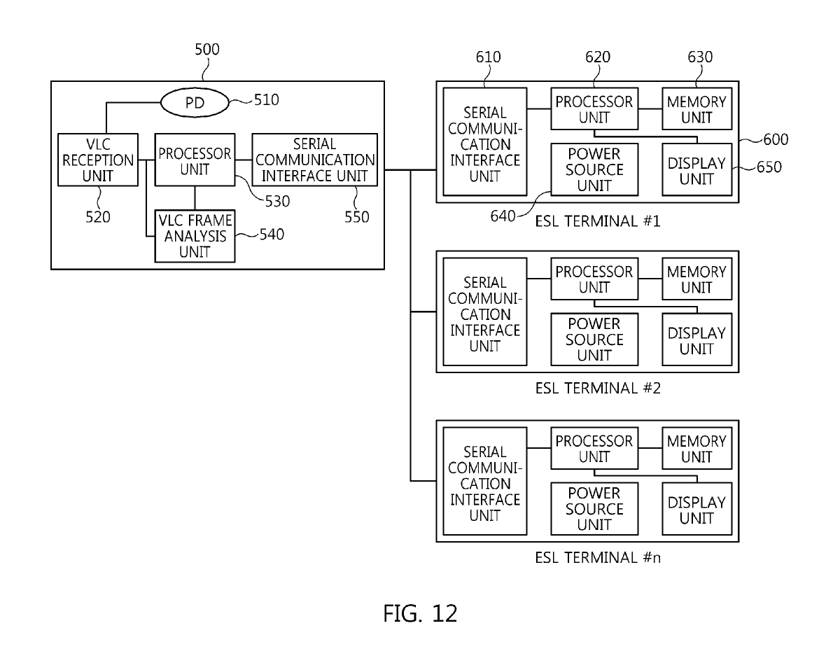

The operation of the LED light 400 configured as described above is described in detail with reference to FIG. 11.

FIG. 11 is a flowchart illustrating the operation of the LED light according to an embodiment of the present invention.

First, the LED light 400 determines whether received data is VLC data or light control data.

Referring to FIG. 11, the LED light 400 checks whether VLC data has been received at step S401.

If, as a result of the checking, it is determined that the VLC data has not been received, the LED light 400 checks whether light control data has been received at step S402. If, as a result of the checking at step S402, it is determined that the light control data has been received, the LED light 400 controls the state of the LED light (e.g., the turn-on/off and PWM dimming of the LED light) based on the light control data at step S403.

If, as a result of the checking at step S401, it is determined that the VLC data has been received, the LED light 400 stores the VLC data in the memory unit 440 and sends an Ack message indicating that the VLC data has been received to the lighting control scheduler 200 at step S404.

The LED light 400 configures the VLC data in accordance with a VLC data frame that can be recognized by the VLC receiver 500 at step S405.

Thereafter, in order to send the VLC data configured at step S405 while maintaining the brightness of the LED light, the LED light 400 performs VLC dimmable modulation at step S406, and drives an LED to wirelessly transmit the VLC data at step S407.

The configurations of the VLC receiver 500 and the ESL terminal 600 are described in detail below with reference to FIG. 12.

FIG. 12 is a diagram schematically illustrating the configurations of the VLC receiver and the ESL terminal according to embodiments of the present invention.

Referring to FIG. 12, the VLC receiver 500 performs communication with one or more ESL terminals #1 to #n.

The VLC receiver 500 may include a photodiode (hereinafter referred as a “PD”) 510, a VLC reception unit 520, a processor unit 530, a VLC frame analysis unit 540, and a serial communication interface unit 550.

The PD 510 receives VLC light data transmitted by the LED light 400.

The VLC reception unit 520 converts the received VLC light data into an electrical signal.

The processor unit 530 controls the operation of the VLC reception unit 520.

The VLC frame analysis unit 540 analyzes a VLC data frame in order to check whether the VLC data converted into an electrical signal corresponds to its own data.

The serial communication interface unit 550 transfers the VLC data to the ESL terminal 600.

Each of the ESL terminals 600 may include a serial communication interface unit 610, a processor unit 620, a memory unit 630, a power source unit 640, and a display unit 650.

The serial communication interface unit 610 receives VLC data from the VLC receiver 500.

The processor unit 620 controls the operation of the ESL terminal 600.

The memory unit 630 stores the received VLC data.

The power source unit 640 supplies power to the ESL terminal 600.

The display unit 650 displays product information including the stored VLC data.

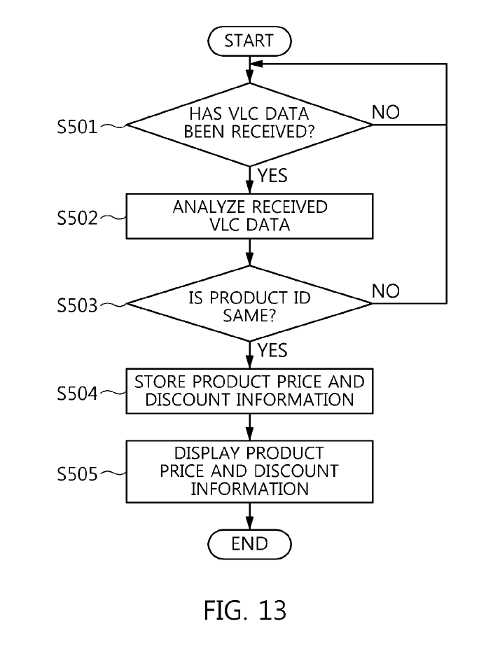

The operation of the ESL terminal 600 is described in detail below with reference to FIG. 13.

FIG. 13 is a flowchart illustrating the operation of the ESL terminal according to an embodiment of the present invention.

Referring to FIG. 13, the ESL terminal 600 checks whether VLC data has been received from the VLC receiver 500 at step S501.

If, as a result of the checking, it is determined that the VLC data has been received, the ESL terminal 600 analyzes the received VLC data at step S502.

At step S503, the ESL terminal 600 checks whether a product ID included in the VLC data is identical with a set corresponding product ID as a result of the analysis at step S502. In this case, the set corresponding product ID is the ID of a product corresponding to an ESL displayed by the ESL terminal 600.

If, as a result of the checking at step S503, it is determined that the product ID included in the VLC data is identical with the set corresponding product ID, the ESL terminal 600 stores a product price and discount information included in the VLC data at step S504. Furthermore, the ESL terminal 600 may provide a consumer with changed information by displaying the product price and discount information at step S505.

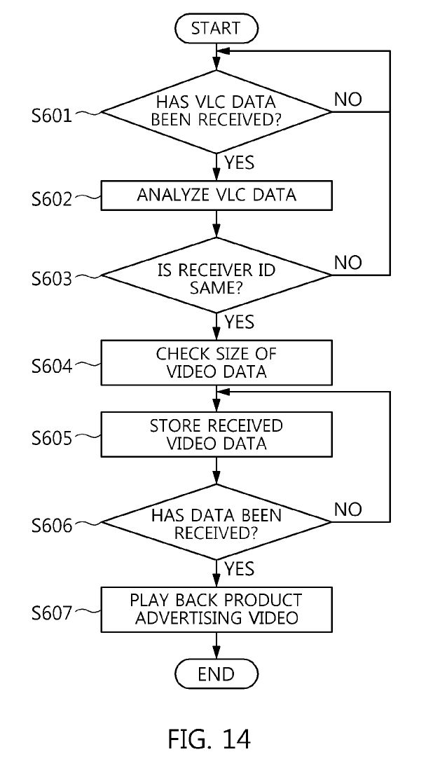

A process of playing back a product advertising video on the video player 700 connected to the VLC receiver 500 is described in detail below with reference to FIG. 14.

FIG. 14 is a flowchart illustrating a process of playing back a product advertising video on the video player connected to the VLC receiver according to an embodiment of the present invention.

Referring to FIG. 14, the video player 700 checks whether VLC data, such as that of FIG. 4, has been received from the VLC receiver 500 at step S601.

If, as a result of the checking, it is determined that the VLC data has been received, the video player 700 analyzes the received VLC data at step S602.

At step S603, the video player 700 checks whether a receiver ID included in the VLC data is identical with a set receiver ID as a result of the analysis at step S602.

If, as a result of the checking at step S603, it is determined that the receiver ID included in the VLC data is identical with the set receiver ID, the video player 700 checks the size of video data (i.e., product advertisement data) at step S604.

The video player 700 stores the video data including the received VLC data at step S605.

The video player 700 checks whether the VLC data has been completely received at step S606. If, as a result of the checking at step S606, it is determined that the VLC data has been completely received, the video player 700 plays back a product advertising video at step S607.

In the past, in order to change a product advertising video installed in a shop, a video file must be changed off-line or a separate network must be constructed. In the shop management technology using a lighting network and visible light communication according to the present embodiment, however, a high-capacity product advertising video file may be easily changed or updated.

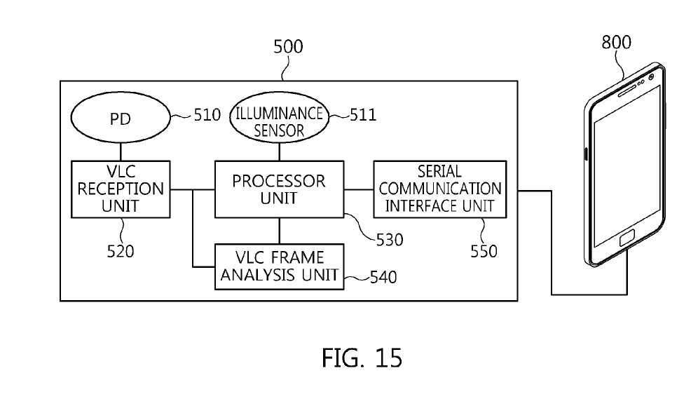

The configuration of the VLC receiver for the portable manager device 800 is described in detail below with reference to FIG. 15.

FIG. 15 is a diagram schematically illustrating the configuration of a VLC receiver 500 for a portable manager device 800 according to an embodiment of the present invention.

First, the VLC receiver 500 may be connected to a smart device or dedicated terminal capable of Wi-Fi communication, for example, the portable manager device 800, via serial communication.

Referring to FIG. 15, the VLC receiver 500 connected to the portable manager device 800 may further include an illuminance sensor 511 in order to check the state of an LED light, unlike the VLC receiver 500 for the ESL terminal 600.

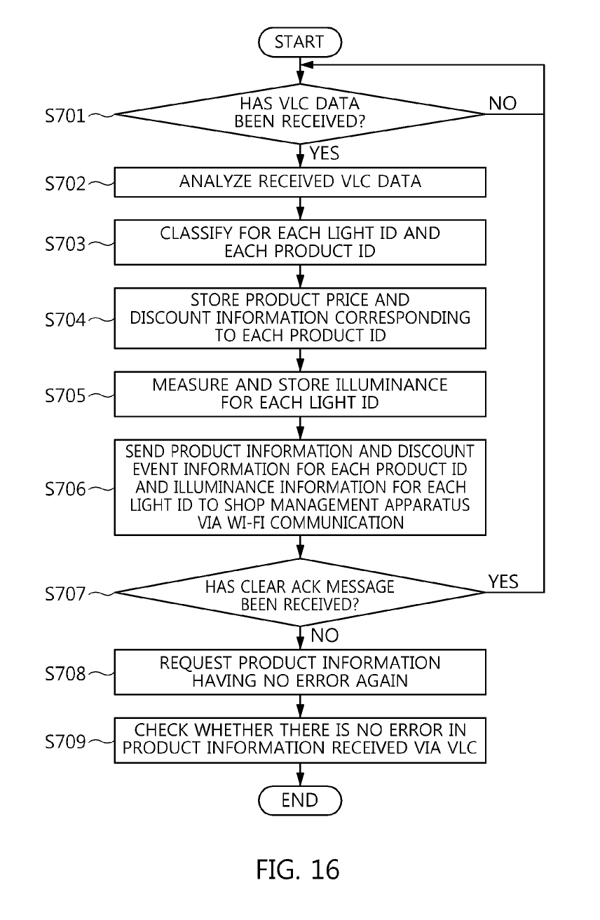

The operation of the portable manager device 800 is described in detail below with reference to FIG. 16.

FIG. 16 is a flowchart illustrating the operation of the portable manager device 800 according to an embodiment of the present invention.

Referring to FIG. 16, the portable manager device 800 checks whether VLC data has been received from the VLC receiver 500 at step S701.

If, as a result of the checking, it is determined that the VLC data has been received, the portable manager device 800 analyzes the received VLC data at step S702.

The portable manager device 800 classifies the results of the analysis of the VLC data for each light ID and each product ID at step S703.

The portable manager device 800 stores the results classified for each product ID, i.e., a product price and discount information for each product ID, at step S704.

The portable manager device 800 stores the results classified for each light ID, i.e., the result of the measurement of illuminance and illuminance information corresponding to the results of the measurement for each light ID, at step S705.

The portable manager device 800 sends the product information and discount event information for each product ID and the illuminance information, stored at steps S704 and S705, to the shop management apparatus 100 via Wi-Fi communication at step S706.

The portable manager device 800 checks whether a clear Ack message indicating that there is no error in product information for each product ID has been received at step S707.

If, as a result of the checking, it is determined that the clear Ack message has not been received, the portable manager device 800 requests product information for each product ID, having no error, from the shop management apparatus 100 again at step S708.

The portable manager device 800 checks whether there is no error in product information for each product ID received via VLC at step S709.

As described above, in accordance with at least some embodiments of the present invention, the apparatus and method for managing a shop using a lighting network and visible light communication operate in conjunction with a lighting control system. Accordingly, changed product price information and changed discount event information can be provided to consumers in real time, and whether the changed information has been correctly displayed can be easily checked by collecting information, transmitted by LED lights, using the portable manager device. Furthermore, the repair and maintenance of LED lights within a shop can be easily performed because the states of the LED lights within the shop that are controlled by the lighting control scheduler can be measured and reported for each light ID.

As described above, the optimum embodiments have been disclosed in the drawings and the specification. Although specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true ranges of protection of the present invention should be defined based on the technical spirit of the attached claims.

What is claimed is:

1. A method of managing a shop, comprising:
receiving, by a shop management apparatus, product information and discount event information within a shop;
comparing the product information and the discount event information with previously stored information, sending changed product information and changed discount event information, acquired based on a result of the comparison, to a lighting control scheduler, and receiving a corresponding reception Ack message;
receiving visible light communication (VLC) data and illuminance information for each light identification (ID), corresponding to the product information and the discount event information, from a portable manager device; and
checking an error of the VLC data, checking illuminance of a corresponding LED light within the shop based on the illuminance information, and then managing the shop.

2. The method of claim 1, wherein receiving the VLC data and the illuminance information comprises receiving the VLC data and the illuminance information via Wi-Fi communication.

3. The method of claim 1, further comprising, after receiving the reception Ack message:
searching for, by the lighting control scheduler, an Internet Protocol (IP) address of an light-emitting diode (LED) light corresponding to each light ID; and
sending product information and discount event information, corresponding to each product ID, to the LED light using the IP address of the LED light, and receiving a corresponding reception Ack message.

4. The method of claim 3, wherein the lighting control scheduler and the LED light are connected over a lighting network.

5. The method of claim 1, further comprising sending, by the LED light, the product information and the discount event information to an ESL device or the portable manager device within the shop using a corresponding VLC receiver via VLC.

6. The method of claim 1, wherein managing the shop comprises controlling product advertising video data included in the VLC data so that the product advertising video data is played back using a video player installed in the shop.

7. An apparatus for managing a shop, comprising:
an input unit configured to receive product information and discount event information within a shop;
a product information management unit configured to compare the product information and the discount event information with previously stored information, to send changed product information and changed discount event information, acquired based on a result of the comparison, to a lighting control scheduler, and to receive a corresponding reception Ack message;
a communication unit configured to receive VLC data and illuminance information for each light ID, corresponding to the product information and the discount event information, from a portable manager device; and
a shop management unit configured to check an error of the VLC data, to check illuminance of a corresponding LED light within the shop based on the illuminance information, and to then manage the shop.

8. The apparatus of claim 7, wherein the communication unit receives the VLC data and the illuminance information via Wi-Fi communication.

9. The apparatus of claim 7, wherein, after the product information management unit has received the reception Ack message, the lighting control scheduler searches for an IP address of an LED light corresponding to each light ID and sends product information and discount event information, corresponding to each product ID, to the LED light using the IP address of the LED light.

10. The apparatus of claim 9, wherein the lighting control scheduler and the LED light are connected over a lighting network.

11. The apparatus of claim 7, wherein the LED light sends the product information and the discount event information to an ESL device or the portable manager device within the shop using a corresponding VLC receiver via VLC.

12. The apparatus of claim 7, wherein the shop management unit performs control so that product advertising video data included in the VLC data is played back using a video player installed in the shop.
